(19) United States
(12) Patent Application Publication
(10) Pub. No.: US 2022/0378096 A1
(43) Pub. Date: Dec. 1, 2022

(54) E-Liquid Agitator

(71) Applicant: 2792684 ONTARIO INC., Inverhuron (CA)

(72) Inventor: Farhad Riazi Kermani, Waterloo (CA)

(73) Assignee: 2792684 ONTARIO INC., Inverhuron (CA)

(21) Appl. No.: 17/335,760

(22) Filed: Jun. 1, 2021

(51) Int. Cl. A24F 40/42; A24F 40/10; A24F 40/57; A24F 40/51; A24F 40/44; A24F 40/46

(52) U.S. Cl. CPC A24F 40/42; A24F 40/10; A24F 40/57; A24F 40/51; A24F 40/44; A24F 40/46; B06B 1/0207

(57) ABSTRACT

Buildup of the combustion products of e-liquid residues can be mitigated through the use of an agitation system that applies a vibration to the e-liquid storage pod. This vibration induces agitation, which may be further supported by low levels of heating, to help fresh e-liquid to dissolve precipitate left over from vaporization. Dissolution of these precipitates prevents their buildup. This buildup can result in the generation of a residue that can interfere with the capillary action of the wick. Any residue is subjected to repeated heating which may result in the generation of combustion products.

### CROSS REFERENCE TO RELATED APPLICATIONS

This is the first application for the instant invention.

### TECHNICAL FIELD

This application relates generally to a method of removing precipitate from a heater in a vaporizing system, and more particularly to a method of agitating a wick to aid in re-dissolution of precipitate for use in conjunction with an electronic cigarette or vaporizer.

### BACKGROUND

Electronic cigarettes and vaporizers are well regarded tools in smoking cessation. In some instances, these devices are also referred to as an electronic nicotine delivery system (ENDS). A nicotine based liquid solution, commonly referred to as e-liquid, often paired with a flavoring, is atomized in the ENDS for inhalation by a user. In some embodiments, e-liquid is stored in a cartridge or pod, which is a removable assembly having a reservoir from which the e-liquid is drawn towards a heating element by capillary action through a wick. In many such ENDS, the pod is removable, disposable, and is sold pre-filled.

In some ENDS, a refillable tank is provided, and a user can purchase a vaporizable solution with which to fill the tank. This refillable tank is often not removable, and is not intended for replacement. A fillable tank allows the user to control the fill level as desired. Disposable pods are typically designed to carry a fixed amount of vaporizable liquid, and are intended for disposal after consumption of the e-liquid. The ENDS cartridges, unlike the aforementioned tanks, are not typically designed to be refilled. Each cartridge stores a predefined quantity of e-liquid, often in the range of 0.5 to 3 ml. In ENDS systems, the e-liquid is typically composed of a combination of any of vegetable glycerine, propylene glycol, nicotine and flavorings. In systems designed for the delivery of other compounds, different compositions may be used.

In the manufacturing of the disposable cartridge, different techniques are used for different cartridge designs. Typically, the cartridge has a wick that allows e-liquid to be drawn from the e-liquid reservoir to an atomization chamber. In the atomization chamber, a heating element in communication with the wick is heated to encourage aerosolization of the e-liquid. The aerosolized e-liquid can be drawn through a defined air flow passage towards a user's mouth.

FIGS. 1A, 1B and 1C provide front, side and bottom views of an exemplary pod 50. Pod 50 is composed of a reservoir 52 having an air flow passage 54, and an end cap assembly 56 that is used to seal an open end of the reservoir 52. End cap assembly 56 has wick feed lines 58 which allow e-liquid stored in reservoir 52 to be provided to a wick (not shown in FIG. 1). To ensure that e-liquid stored in reservoir 52 stays in the reservoir and does not seep or leak out, and to ensure that end cap assembly 56 remains in place after assembly, seals 60 can be used to ensure a more secure seating of the end cap assembly 56 in the reservoir 52. In the illustrated embodiment, seals 60 may be implemented through the use of o-rings.

As noted above, pod 50 includes a wick that is heated to atomize the e-liquid. To provide power to the wick heater, electrical contacts 62 are placed at the bottom of the pod 50. In the illustrated embodiment, the electrical contacts 62 are illustrated as circular. The particular shape of the electrical contacts 62 should be understood to not necessarily germane to the function of the pod 50.

Because an ENDS device is intended to allow a user to draw or inhale as part of the nicotine delivery path, an air inlet 64 is provided on the bottom of pod 50. Air inlet 64 allows air to flow into a pre-wick air path through end cap assembly 56. The air flow path extends through an atomization chamber and then through post wick air flow passage 54.

FIG. 2 illustrates a cross section taken along line A in FIG. 1B. This cross section of the device is shown with a complete (non-sectioned) wick 66 and heater 68. End cap assembly 56 resiliently mounts to an end of air flow passage 54 in a manner that allows air inlet 64 to form a complete air path through pod 50. This connection allows airflow from air inlet 64 to connect to the post air flow path through passage 54 through atomization chamber 70. Within atomization chamber 70 is both wick 66 and heater 68. When power is applied to contacts 62, the temperature of the heater increases and allows for the volatilization of e-liquid that is drawn across wick 66.

Typically the heater 68 reaches temperatures well in excess of the vaporization temperature of the e-liquid. This allows for the rapid creation of a vapor bubble next to the heater 68. As power continues to be applied the vapor bubble increases in size, and reduces the thickness of the bubble wall. At the point at which the vapor pressure exceeds the surface tension the bubble will burst and release a mix of the vapor and the e-liquid that formed the wall of the bubble. The e-liquid is released in the form of aerosolized particles and droplets of varying sizes. These particles are drawn into the air flow and into post wick air flow passage 54 and towards the user.

As noted above, the e-liquid is delivered to the user in two forms: a vapor caused by the heating of e-liquid, and droplets of varying sizes caused by the vapor rupturing the surface of the bubble. The e-liquid is a solution of a number of different components, each of which can have its own specific vaporization temperature. Typically the temperature of the heater is set to allow for vaporization of a component such as the vegetable glycerine or the propylene glycol as they represent the largest fraction of the e-liquid. This allows for the vaporization to occur quickly, and results in good droplet production. Some of the components may be dissolved in the e-liquid solution and may not evaporate at the heater temperature if at all. As a result, the portion of the e-liquid that is turned to a vapour is likely to leave behind a precipitate. This precipitate is often a flavorant or a compound used to provide a sweetness to the vaping experience. The resultant precipitate will accumulate at the site of the evaporation.

As the number of heating cycles increases, the amount of precipitate that is left behind increases. It has been observed that some vaping systems will accumulate a residue that becomes darker over time. It is believed that this residue may be a result of the burning of this precipitate. Additionally, the precipitate may interfere with the ability of the wick to transport e-liquid through capillary action. In such an event, the presence of the precipitate may contribute to the phenomenon of burnt-hits where there is an insufficient amount of e-liquid in the wick and the wick itself is burned as a result of the activation of the heater.

The heating of the precipitate may result in more than an aesthetically unpleasant buildup residue. The residue itself is subjected to the heating cycle intended to vaporize e-liquid, which often involves temperatures in excess of 200° C. This may result in either a “caramelization” of the sugars and sugar substitutes, or in combustion of the precipitate.

Accordingly, the presence of the precipitate in the wick after vaporization is generally unwanted, and it would be beneficial to have a mechanism to mitigate the results of the accumulation of the precipitate.

### SUMMARY

It is an object of the aspects of the present invention to obviate or mitigate the problems of the above-discussed prior art.

In accordance with a first aspect of the present invention, there is provided an electronic vaping system that makes use of a vibration driver to induce vibrations within at least one of the wick and heater. The vaping system comprises a pod and a device. The pod has a reservoir for storing an atomizable liquid, a wick for drawing the stored atomizable liquid from the reservoir to an atomization chamber, and a heater for atomizing the liquid drawn across the wick. The device comprises a battery for storing electrical power, a vibration driver and a processor. The processor can be used for controlling application of the stored electrical power to the heater and for directing the vibration driver to induce a vibration in the pod to encourage dissolution of precipitate from atomized liquid into remaining atomizable liquid.

In an embodiment of the first aspect of the present invention, the atomizable liquid is an e-liquid comprising at least one of vegetable glycerine, propylene glycol, nicotine and flavorings. In another embodiment the processor controls application of the stored electrical power to the heater in accordance with an input signal received from a switch, where optionally the switch is embodied within a pressure sensor. In another embodiment, the vibration driver generates a vibration in the device directed towards the pod, where optionally, the generated vibration induces sonication within the pod. Alternatively, the vibration driver optionally comprises at least one of a piezo electric transducer, an electromechanical transducer, an electroacoustic transducer and a tactile transducer.

In another embodiment, the vibration driver transmits an electrical control signal to a sonication probe within the pod in response to a control signal received from the processor. In some embodiments, the sonication probe is embedded within the wick. In another embodiment, the sonication probe comprises at least one of a piezo electric transducer, an electromechanical transducer, an electroacoustic transducer and a tactile transducer.

In another embodiment, the processor is configured to apply electrical power to the heater in conjunction with controlling the vibration driver to induce vibration within the pod. In a further embodiment, the processor is configured to apply electrical power to the heater and control the vibration driver to induce vibration within the pod simultaneously.

### BRIEF DESCRIPTION OF THE DRAWINGS

Embodiments of the present invention will now be described in further detail by way of example only with reference to the accompanying figure in which:

FIG. 1A is a front view of a prior art pod for use in an ENDS, with a cross sectioned mouthpiece;

FIG. 1B is a side view of the pod of FIG. 1A;

FIG. 1C is a bottom view of the pod of FIG. 1A;

FIG. 2 is a cross section view of the pod of FIGS. 1A, 1B and 1C, shown along section line A-A in FIG. 1B;

FIG. 3 illustrates an embodiment of an ENDS that makes use of a vibration driver to encourage re-dissolving of precipitate; and

FIG. 4 illustrates an embodiment of a wick with an embedded sonication probe.

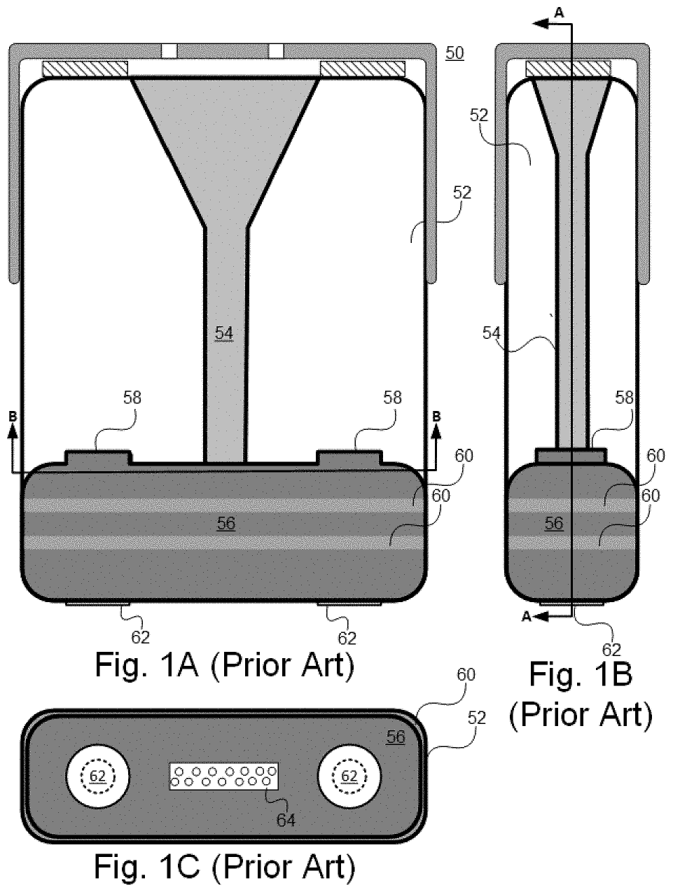

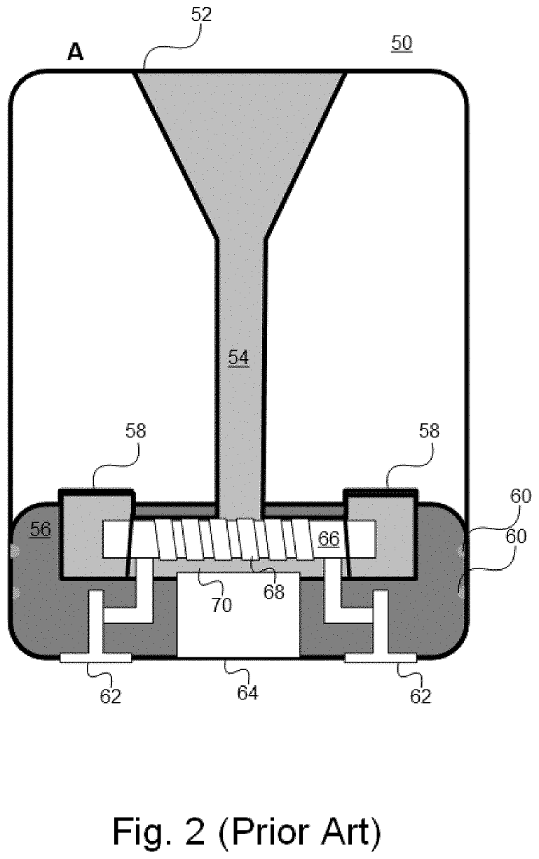

In the above described figures like elements have been described with like numbers where possible.

### DETAILED DESCRIPTION

In the instant description, and in the accompanying figures, reference to dimensions may be made. These dimensions are provided for the enablement of a single embodiment and should not be considered to be limiting or essential. Disclosure of numerical range should be understood to not be a reference to an absolute value unless otherwise indicated. Use of the terms about or substantively with regard to a number should be understood to be indicative of an acceptable variation of up to ±10% unless otherwise noted.

Although presented below in the context of use in an electronic nicotine delivery system such as an electronic cigarette (e-cig) or a vaporizer (vape) it should be understood that the scope of protection need not be limited to this space, and instead is delimited by the scope of the claims. Embodiments of the present invention are anticipated to be applicable in areas other than ENDS, including (but not limited to) other vaporizing applications.

The process through which a particular e-liquid is produced is typically a process that is not disclosed by the manufacturer. But it is understood that many of the flavorants and sweeteners added to the e-liquid may not dissolve quickly and easily. These components are also those that are believed to be the most likely to precipitate out of the solution during the evaporation process.

In embodiments of the present invention, modifications to at least one of the ENDS and ENDS pod are provided to aid in re-dissolution of the precipitate. By dissolving the precipitate in the existing e-liquid the buildup of the precipitate is avoided. By avoiding the buildup of the precipitate, both the burning of the precipitate and the impacts of the precipitate on the wick can be mitigated.

In conventional operation, a user activates a vaping device, either by drawing on the device, or by pressing a button and inhaling. This results in activation of the heater in conjunction with the creation of an airflow through the pod. Power is provided to the heater, and e-liquid that has been drawn from the reservoir to the heater by the wick is vaporized. The rupturing of an e-liquid bubble by the vaporized e-liquid results in droplets that are carried by the airflow towards the user. Non-vaporized components of the e-liquid are deposited on or near the heaters. Capillary action results in the wick bringing fresh e-liquid towards the heater to replace e-liquid and e-liquid components carried away in the air flow.

The e-liquid carried by the wick towards the heater can be used to prevent the buildup of precipitate. The precipitate is only attributable to the vaporized portion of e-liquid, which is a small portion of the overall amount of e-liquid provided to the user, most of which is associated with the droplets caused by the rupturing of the bubble by the vapor. As such, fresh e-liquid, so long as it is not at its carrying capacity for the components of the precipitate, can be used to dissolve the precipitate. This amounts to a re-dissolution of the precipitate which prevents its buildup at or near the heater. Additionally, this can reduce buildup of the precipitate or its combustion products on or within the wick, which mitigates the impact of the precipitate on the capillary action of the wick.

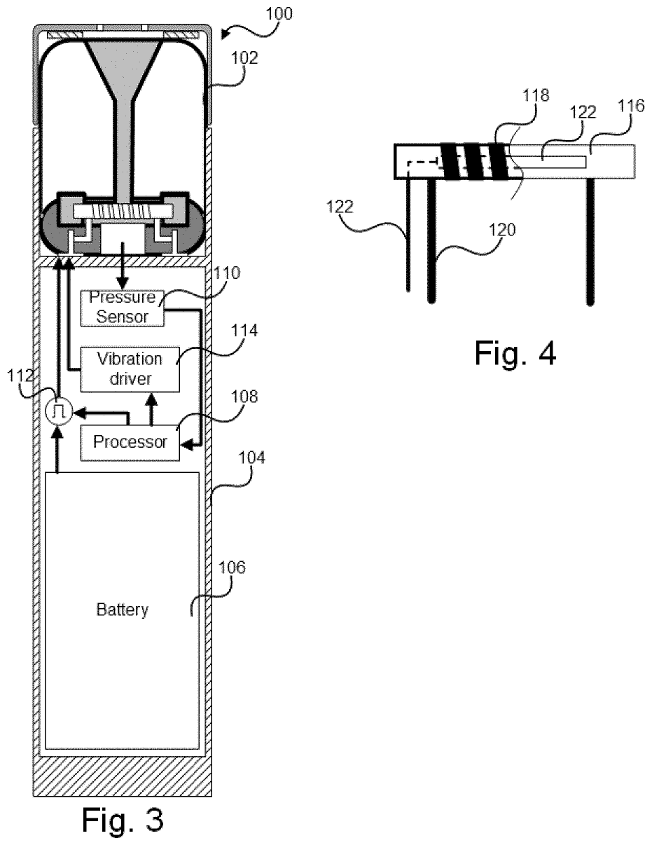

FIG. 3 illustrates an example of an ENDS 100 having both a pod 102 similar in structure to the pod illustrated in the prior art, and a device 104. The illustration of FIG. 3 shows the ENDS as a cross section. The cross section of pod 102 shows exemplary physical structures, while the cross section of device 104 illustrates logical components and their logical connections. Device 104 is often referred to as a battery, because it houses battery 106 which typically occupies most of the available volume within device 104. Battery 106 is typically rechargeable through an unillustrated interface, and holds a charge that is used to power the wick of pod 102. Processor 108 receives a variety of inputs and controls the operation of device 104. Processor 108 can be implemented as a programmable processor or controller accessing instruction stored in an unillustrated memory. One of the inputs to processor 108 is pressure sensor 110. When a user draws on the device, an airflow is created within pod 102, and results in activation of pressure sensor 110. An activation signal can be sent from pressure sensor 110 to processor 108 to indicate that the user is drawing on the device. Processor 108, upon receipt of the activation signal, controls a signal generator 112 to produce an activation current that is provided to pod 102 to power the heater. Signal generator 112 can produce a number of different activation signals, for example, a pulse width modulation (PWM) signal. By using a PWM signal, signal generator 112 allows for the delivery of an average power or voltage that is below the power or voltage that would be delivered by the battery 106. For example, if a battery is designed to provide a voltage output of 4.3V, and the ENDS 100 has been designed around an operating voltage of 3.8V, a PWM signal can be generated that over a specified time interval provides 3.8V average power. Additionally, if the battery 106 provides a reduced voltage over its life, the PWM pattern can be adjusted so that for any battery output voltage, the average voltage delivered remains 3.8V. Adjustment of the PWM pattern may be a function provided by the processor 108 in communication with the battery 106 and signal generator 112.

A vibration driver 114 is an additional element that can be controlled by the processor 108. In some embodiments, vibration driver 114 is designed to transmit vibrations into pod 102. In some embodiments, it provides sonication to the pod 102. By transmitting vibration into pod 102, the e-liquid is subjected to agitation. Where the e-liquid and precipitate are close to each other, this will encourage re-dissolution of the precipitate into the e-liquid. Agitation of e-liquid is functionally similar to the stirring of the e-liquid during its manufacturing process, and through agitation, the precipitate can be prevented from accumulating on the heater and within the wick.

The activation of the vibration driver 114 can be controlled by the processor 108. This can be done to avoid causing activation of the vibration driver 114 at times that would be detrimental to the operation of the ENDS 100. For example, in some embodiments, the activation of the vibration driver 114 may not be desired during the use of the device 100, in such a case, processor 100 may prevent activation of the vibration driver 114 while the heater is being powered to volatilize the e-liquid. Similarly, it may be desirable to prevent vibration when the device is in particular orientations. If ENDS 100 includes orientation sensors, these can be used by the processor 108 to determine when ENDS 100 is upright so that vibration driver 114 can be activated. In other embodiments, processor 108 may refrain from activating vibration driver 114 when pod 102 is not inserted into device 104.

It should be understood that it may not be necessary to induce agitation through the use of vibration driver 114 after every use of the ENDS 100. In some embodiments, it may be possible to delay agitation until the ENDS 100 has been used for either a predefined number of heating cycles, or for a predefined amount of time during which the heater has been powered. In such embodiments, the processor 108 may initiate a countdown timer from the end of the use of ENDS 100. After a set amount of time, processor 108 may trigger vibration driver 114. This may coincide with the ENDS 100 entering a low-power sleep mode and serve as both the driver of agitation and a notification to the user of the low-power mode. It should be understood that the application of the vibration may be supported by providing a low level of power to the heater so that a moderate temperature increase is provided and the e-liquid nearest the heater, which is also the location of much of the precipitate, is increased to support absorption of the precipitate. The power level provided to the heater for this dissolution support will vary between different implementations of the heater, the wick and the e-liquid.

The particular frequency and amplitude of vibration required from vibration driver 114 is a function of the shape and structure of device 104, the placement of vibration driver 114 within the device 114, the particular structure of pod 102 and the formulation of the e-liquid in question. However, one factor that does remain constant is that the delivery of energy into pod 102 by the vibration driver 114 is subject to an inverse square law, where the power delivered is proportional to the inverse of the square of the distance between the vibration driver 114 and the heater within pod 102. Thus, while the function of the vibration driver 114, and its control, may remain within device 104, the physical element delivering the vibration may be located within pod 102. This may require an additional electrical interface between the pod 102 and device 104, the details of which will be apparent to those skilled in the art.

By locating a vibrating element within a pod, and possibly within the wick itself, a sonication probe may be used. FIG. 4 illustrates an exemplary embodiment of such a wick 116. Wick 116 of FIG. 4 is illustrated in partial cross section. Wick 116 is engaged with heater 118 which is coiled around wick 116, and terminates on opposing sides with heater leads 120 which may connect to the electrical leads of the pod. Within wick 116 is situated a sonication probe 122, which connects through sonication lead 124 to the vibration driver 112 within device 104. Those skilled in the art will appreciate that in such an embodiment, vibration driver 112 may no longer be required to produce the vibrations directed to pod 102, and instead may be simply required to provide an electrical control to the sonication probe 122. Those skilled in the art will appreciate that sonication makes use of sound waves that are used to agitate a solution to encourage the mixing of a solution. In this instant example the precipitate from previous evaporations is mixed with fresh e-liquid to dissolve the precipitate. This may be done using a sonication probe 122, acting as a resonator, inducing vibrations in the pod. Typically, sonication makes use of frequencies above those associated with human hearing. It may result in the creation and collapse of very small bubbles in the e-liquid nearest to the wick 116. This may aid in breaking the precipitate into smaller pieces that would be more easily dissolved in the e-liquid, and in agitation of the e-liquid to promote dissolution.

In such an embodiment, control of the sonication probe can allow for direct agitation of the wick 116, heater 118 and the e-liquid surrounding it. Because of the physical proximity of the sonication probe 122, the power and force required are reduced. In such embodiments, it may be possible to agitate the solution without it being disruptive to the user experience.

Typically the source of vibrations, whether it is the vibration driver 112 or the sonication probe 122 is an electromechanical or electroacoustic transducer. Based on the power required for agitation, the placement of the transducer and the frequency with which vibrations are to be delivered, the design parameters for the transducer can be determined, and an appropriate transducer selected. In some implementations a tactile transducer may be selected, while in others a piezoelectric transducer may be used. It should be understood that the use of such a transducer is intended to cause agitation within the e-liquid and is not necessarily intended to aerosolize the e-liquid.

One such known piezoelectric transducer is a quartz crystal. The application of a voltage difference across the crystal induces a vibration, the frequency of which can be determined by the size and shape of the crystal. Thus, the selection of a shaped crystal can set the frequency of the sonication probe 122, while the amplitude of the vibration induced in the probe 122 can be controlled by the voltage applied to the crystal.

In other embodiments, the vibrations within the wick can be induced through the use of electromagnetically induced vibration. An electromagnetic signal can be transmitted towards the heating coil surrounding the wick, causing the coil to vibrate. In some embodiments, the heating coil can be treated as an inductor and magnetic energy caused by an alternating electrical current can be stored in the airgap of the magnetic circuit, where large Maxwell forces apply. This technique will generate vibrations in accordance with the airgap and the geometry of a magnetic circuit. In other embodiments, the heater coil may be coupled to a capacitor. By providing a voltage or current waveform that is non-constant, the capacitor may be subjected to harmonic resonance which can generate vibrations. In both of these electromagnetically driven embodiments, it should be understood that the vibrations may be accompanied by a sound that is associated with the overall vibration frequency.

The particular design of an electromagnetic vibration circuit will vary with the design of the vaping device and the wick structure, but these implementation details will be well understood by those skilled in the art. Typically electromagnetic induced acoustic vibrations are considered to be a condition that should be avoided in design, and remedied when experienced. However, the intentional creation of these vibrations allows for a beneficial result to be utilized.

Although much of the above discussion has been focused on vaping systems that make use of re-usable pods, it should be understood that they can also be applied to vaping devices that make use of an integrated and refillable tank. In these systems, wicks and heaters are employed, but are also typically user replaceable. In many such systems the buildup of residue on a wicking and heating system may impair the wicking capabilities of a ceramic wick, or the may result in depositions on heater coils that prevent even and reliable heat delivery. These negative effects may shorten the life of otherwise long life components such as heater coils. The inclusion of a vibration function to aid in cleaning through the life of the heater coil or wick, may aid in the extension of the life of these components. Because the vibration engine is not implemented in a disposable item like a pod, it can be placed close to the wick and heater, and it can make use of components too expensive for a disposable pod while still being economically viable.

In the instant description, and in the accompanying figures, reference to dimensions may be made. These dimensions are provided for the enablement of a single embodiment and should not be considered to be limiting or essential. The sizes and dimensions provided in the drawings are provided for exemplary purposes and should not be considered limiting of the scope of the invention, which is defined solely in the claims.

1. An electronic vaping system comprising:
a pod comprising a reservoir for storing an atomizable liquid, a wick for drawing the stored atomizable liquid from the reservoir to an atomization chamber, and a heater for atomizing the liquid drawn across the wick; and
a device comprising:
a battery for storing electrical power;
a vibration driver; and
a processor, for controlling application of the stored electrical power to the heater and for directing the vibration driver to induce a vibration in the pod to encourage dissolution of precipitate from atomized liquid into remaining atomizable liquid.

2. The electronic vaping system of claim 1 wherein the atomizable liquid is an e-liquid comprising at least one of vegetable glycerine, propylene glycol, nicotine and flavorings.

3. The electronic vaping system of claim 1 wherein the processor controls application of the stored electrical power to the heater in accordance with an input signal received from a switch.

4. The electronic vaping system of claim 3 wherein the switch is a pressure sensor.

5. The electronic vaping system of claim 1 wherein the vibration driver generates a vibration in the device directed towards the pod.

6. The electronic vaping system of claim 5 wherein the generated vibration induces sonication within the pod.

7. The electronic vaping system of claim 5 wherein the vibration driver comprises at least one of a piezo electric transducer, an electromechanical transducer, an electroacoustic transducer and a tactile transducer.

8. The electronic vaping system of claim 1 wherein the vibration driver transmits an electrical control signal to a sonication probe within the pod in response to a control signal received from the processor.

9. The electronic vaping system of claim 8 wherein the sonication probe is embedded within the wick.

10. The electronic vaping system of claim 8 wherein the sonication probe comprises at least one of a piezo electric transducer, an electromechanical transducer, an electroacoustic transducer and a tactile transducer.

11. The electronic vaping system of claim 1 wherein the processor is configured to apply electrical power to the heater in conjunction with controlling the vibration driver to induce vibration within the pod.

12. The electronic vaping system of claim 11 wherein the processor is configured to apply electrical power to the heater and control the vibration driver to induce vibration within the pod simultaneously.
